(19) United States
(12) Patent Application Publication
(10) Pub. No.: US 2002/0116706 A1
(43) Pub. Date: Aug. 22, 2002

(54) Selection between an in-band and an out-of-band channel for downloading code to a set top box

(76) Inventor: Ardavan Bahraini, Duluth, GA (US)

Correspondence Address: Richard P. Gilly, Intellectual Property Law Offices, P.C., One Penn Center - Suite 1500, 1617 John F. Kennedy Boulevard, Philadelphia, PA, 19103-1815, US

(21) Appl. No.: 09/735,676

(22) Filed: Dec. 13, 2000

Related U.S. Application Data
(60) Provisional application No. 60/170,548, filed on Dec. 14, 1999.

(51) Int. Cl. H04N 7/173; H04N 7/10

(52) U.S. Cl. 725/32; 725/132; 725/140

(57) ABSTRACT

A cable communication system makes use of a download control message to indicate whether a code object should be downloaded to a set top box via an in-band channel or via an out-of-band channel. In one version, the system includes means for adaptively determining whether to use an in-band channel or an out-of-band channel. The related method includes the steps of receiving a message designating whether to tune to an in-band or an out-of-band channel in order to receive the code object, tuning to the designated channel, and receiving the code object from the designated channel.

### FIELD OF THE INVENTION

The present invention relates to the field of initializing a set-top terminal of a cable communication system, and, in particular, to adaptively choosing between in-band and out-of-band downloading of code objects to a set top box.

### BACKGROUND OF THE INVENTION

A set top box (“STB”) in a cable system generally includes boot code. Such boot code is generally a minimal set of instructions, stored in non-volatile memory, which instructions are executed upon power-up or reset of the STB to accomplish initialization of the STB. In one scenario, the boot code accomplishes the downloading of the next level of code, referred to as the platform code. Once the STB has been fully installed and initialized, the STB generally includes not only platform code, but also operating system code, so-called “loader code”, and application code.

### SUMMARY OF THE INVENTION

According to one preferred aspect of the present invention, a cable communication system has the ability to signal to a set top box whether to use an in-band channel or an out-of-band channel. In one version of the invention, the system is able to designate an in-band versus an out-of-band channel adaptively, that is, in response to a set of parameters, such as bandwidth availability.

### BRIEF DESCRIPTION OF THE DRAWINGS

FIG. 1 is a flow chart illustrating an exemplary method of choosing between an in-band and an out-of-band channel for downloading code objects to a set top box.

### DETAILED DESCRIPTION OF THE INVENTION

In one preferred embodiment, the boot code is stored in a protected sector of flash memory, and the platform code and application code are stored in unprotected sectors of the flash memory.

When the STB is powered-up or reset, the boot code checks the integrity of the flash memory by performing a cyclic redundancy code (“CRC”) check, for example, on the flash. If the CRC test passes, control of the STB is then passed to the platform code. If the CRC check fails, control is retained by the boot code.

A CRC failure indicates that the flash either includes corrupted software or that it has not been programmed, possibly due to this being its first power-up. The boot code then proceeds to attempt to download additional code objects to complete its initialization or reset operation. The code objects received from a digital controller by the boot code generally comprise the platform code, but it is understood that other code objects can be downloaded, including operating system and application code. The platform code is preferably stored in the flash upon downloading, although other storage locations are within the scope of the invention.

The present invention permits code objects, preferably the platform code, to be downloaded from either an out-of-band (“OOB”) channel or an in-band (“IB”) channel. There are circumstances in which it is preferable to download the code objects via an in-band channel. For example, due to OOB channel bandwidth limitations, when bandwidth on an IB channel is available, downloading the code via an IB channel generally reduces the download time.

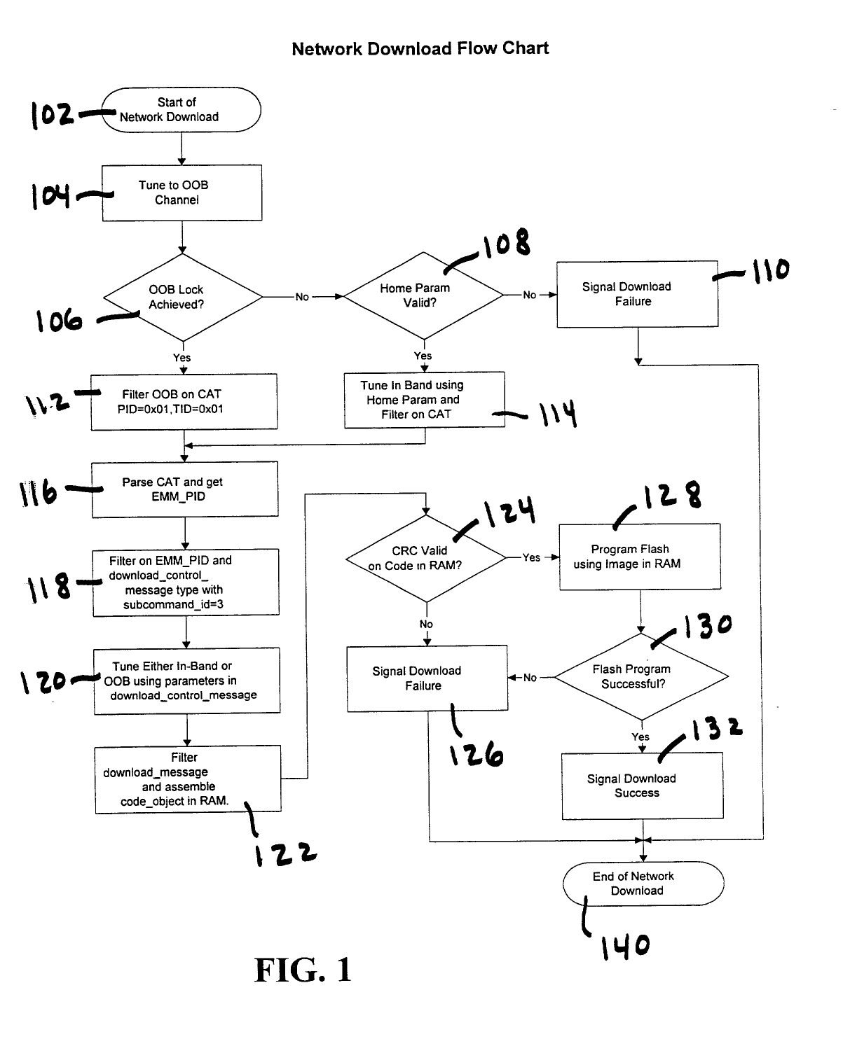

This download process according to the present invention is described with reference to the flow chart of FIG. 1. The network download starts (step 102) when the CRC check of the flash memory fails as described above. Upon CRC failure, the STB attempts to tune (step 104) to an out-of-band (OOB) channel to receive information regarding the location or channel from which it should download appropriate code or software to store in its flash. The boot code may include several pre-stored OOB frequencies and attempt to lock into the OOB channel at each of the pre-stored frequencies and/or may scan a range of frequencies for the OOB channel.

If the STB is unable to lock into the OOB channel (step 106), the STB may try to tune (step 108) to an in-band home channel, such a channel being known in the art, using pre-stored parameters if they exist. If they do not or if the attempt is unsuccessful, a download error message is generated (step 110) and the download process is terminated (step 140). If successful, the boot code filters (step 114) on the home channel for a conditional access table (“CAT”).

If the STB locks onto the OOB channel (step 106), the STB then filters (step 112) the OOB channel for packets having a PID=0×01 and TID (Table ID)=0×01, which are known to contain a conditional access table (CAT). The CAT includes an entitlement management message (“EMM”) PID which is used to identify packets including information for directing the STB to channels where the desired software or code object to download is located.

The STB decodes the CAT for the EMM PID (step 116) and then filters (step 118) the OOB channel (or IB if home channel) for packets having the EMM PID identified in the CAT for a download_control_message with a subcommand_id=3. As explained below, the download_control_message with a subcommand_id=3 identifies whether a code object for a particular STB version should be downloaded on an OOB channel or an IB channel and provides the corresponding parameters for tuning to the channel. An exemplary download_control_message format for the case where subcommand_id=3 is shown in table 1 below.

TABLE 1

| | |
|---|---|
| download_control_message() { | Description |
| subcommand_id | Set to 3 for BootCode |
| | download |
| Subcommand_body | |
| BootCode_download_{—} | |
| channel_map() { | |
| Platform_id | |
| tune_download_function_field | |
| OOB_Download_Flag | {1 = OOB, 0 = In-Band} |
| download_PID | PID for channel |
| if (OOB_download_flag == 1) | |
| OOB_frequency | Per DVB |
| | cable_delivery_system_desc |
| | riptor |
| Else | |
| In_Band_frequency | Per DVB |
| | cable_delivery_system_desc |
| | riptor |
| Symbol_rate | Per DVB |
| | cable_delivery_system_desc |
| | riptor |
| Modulation | Per ETS 300-468 table 22 |
| FEC_outer | ETS 300-468 table 21 |
| FEC_inner | ETS 300-468 table 23 |
| application_ID | identifies the application |
| | code object |
| application_version | reflects current version of |
| | application referenced in |
| | application_id |
| } | |

As shown in table 1 above, a subcommand_id=3 designates that the subcommand_body of the download_control_message includes the boot code download channel map. An exemplary bootcode_download_channel_map is shown in table 1 above.

In the field, there may be several different STB hardware models, each requiring different software. Each STB includes a pre-stored platform ID which identifies its particular version. The different versions of code may be carouselled to accommodate these various different STBs. Each STB can then pick its correct version of code that corresponds to its platform_ID by suitably filtering for a bootcode_download_channel_map that includes a matching Platform_id (see table 1 above).

Once a matching bootcode_download_channel_map has been acquired by the STB, the STB checks the value of the OOB_Download_Flag (see table 1 above). The OOB_Download_Flag indicates whether the STB is to receive the desired code object (which is part of the download_message) by downloading on an OOB channel or an IB channel.

The decision to download using an OOB or an IB channel may be made by an operator who instructs the digital controller to designate an OOB or an IB download of the download_message based on available bandwidth in OOB or IB channels of the cable system. Alternatively, the cable system may include a communication monitor which monitors the cable system to determine which channels have available bandwidth and adaptively signals the digital controller for instructing the STB to download using an OOB or an IB channel. The OOB_Download_Flag may also be set based upon selected criteria, including the relative download time on an OOB channel versus the download time on an IB channel, the size of the application to be downloaded, the extent of disruption to other users of an IB channel, or the type of application being downloaded.

The STB then tunes (step 120) to the OOB or IB channel, as designated by the OOB_Download_Flag, using the communication parameters (symbol_rate, modulation, FEC_outer, FEC_inner, application_ID, and application_version) provided in the BootCode_download_channel_map. The STB filters on this OOB or IB channel to receive the download_message which includes the desired code objects and assembles the desired code as necessary from code_objects in download_messages on this channel (step 122). An exemplary download_message is shown in Table 2 below.

TABLE 2

| | |
|---|---|
| download_message( ) { | Description |
| table_id | |
| section syntax indicator | |
| private indicator | |
| reserved bits | |
| message length | |
| } | |
| download_message_body( ) | |

| | |
|---|---|
| Object_class | {rsrvd, sys_code_loader, |

platform_object, application,
rsrvd}

Object_name
object_version
object size
code_object

CRC
}

The download message includes the desired code object in the download_message_body as shown in table 2 above. The object class indicates the type of object (i.e. code loader, platform code, application code, . . . ) in the code_object. After receiving and assembling the download_message ( ) either from the designated OOB or IB channel (step 122), the boot code extracts the code_object and stores it in RAM.

The above-described in-band/out-of-band selectivity is particularly well-suited for initializing or resetting of a STB. In such application, the code object comprises platform code. Once the platform code has been downloaded and stored in RAM, a CRC check is performed (step 124) to check the integrity of the downloaded object. If the CRC check fails, a download failure message is provided (step 126) and the network download is terminated (step 140). If the CRC check passes, the downloaded object is stored in the flash memory (step 128). The program is then checked again by performing a CRC check on the contents of the flash memory (step 130). If the CRC passes, a download success message is provided (step 132) and the network download is terminated (step 140) and control of the STB is passed to the object that was downloaded.

Although illustrated and described above with reference to certain specific embodiments, the present invention is nevertheless not intended to be limited to the details shown. Rather, those of skill in the art will recognize various modifications in details within the scope and range of equivalents of the principles of the present invention. All such modifications are encompassed by the present invention.

What is claimed is:

1. In a cable communication system, a method for a set top box to receive a software code object, comprising the steps of
receiving a message designating whether to tune to an in-band or an out-of band channel for receiving the code object;
tuning to the designated channel; and
receiving the code object from the designated channel.

2. The method of claim 1, wherein the message includes a download control message having a download flag, and further comprising the steps of reading a value of the download flag to determine whether to download the code object using an in-band or an out-of-band channel

3. The method of claim 1, wherein the code object comprises platform code, and wherein the step of receiving the code object includes downloading the platform code from the cable system by using boot code present in the set top box.

4. The method of claim 2, farther comprising the step of designating the in-band or out-of-band channel for receiving the code object by means of instructions to a digital access controller in communication with the set top box.

5. The method of claim 4, wherein the step of designating the in-band or out-of-band channel includes adaptively deciding between the in-band or out-of-band channel in response to predetermined parameters related to the cable system.

6. The method of claim 5, farther comprising the steps of monitoring available band widths of the cable system and deciding between the in-band or out-of-band channel in response to said monitoring.

7. In a cable communication system having at least one digital access controller, and a plurality of set top boxes in communication with the digital access controller, the improvement comprising:
a download control message including a download flag and information related to a download channel frequency, the download flag capable of corresponding to one of an out-of-bound channel and an in-band channel; and
boot-code for determining the value of the download-control flag, for tuning to the channel indicated in the download control message, and for causing the download of a code object.

8. The system of claim 7, further comprising means for adaptively setting the download flag.

9. The system of claim 8, further comprising means for determining available channel bandwidth, and means for setting the download flag in response to the determination of available channel bandwidth.

10. The system of claim 7, further comprising RAM for storing the code object after downloading and a CRC check to verify proper downloading has occurred.
